(19) United States
(12) Patent Application Publication
(10) Pub. No.: US 2025/0118019 A1
(43) Pub. Date: Apr. 10, 2025

(54) THREE-DIMENSIONAL DATA GENERATION APPARATUS, THREE-DIMENSIONAL DATA GENERATION METHOD, AND NON-TRANSITORY COMPUTER-READABLE MEDIUM

(71) Applicant: NEC Corporation, Tokyo (JP)

(72) Inventor: Akira TSUJI, Tokyo (JP)

(73) Assignee: NEC Corporation, Tokyo (JP)

(21) Appl. No.: 18/897,078

(22) Filed: Sep. 26, 2024

(30) Foreign Application Priority Data
Oct. 6, 2023 (JP) 2023-174564

(51) Int. Cl. G06T 17/00

(52) U.S. Cl. CPC G06T 17/00; G06T 2210/61

(57) ABSTRACT

A three-dimensional data generation apparatus according to the present disclosure includes: an acquisition unit configured to acquire first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region; a correction unit configured to correct a position between first two-dimensional data generated by viewing the first three-dimensional data with a vertically oriented viewpoint from above and second two-dimensional data generated by viewing the second three-dimensional data with a vertically oriented viewpoint from above; and a synthesis unit configured to synthesize the first three-dimensional data and the second three-dimensional data by using a correction result.

### INCORPORATION BY REFERENCE

This application is based upon and claims the benefit of priority from Japanese patent application No. 2023-174564, filed on Oct. 6, 2023, the disclosure of which is incorporated herein in its entirety by reference.

### TECHNICAL FIELD

The present disclosure relates to a three-dimensional data generation apparatus, a three-dimensional data generation method, and a program.

### BACKGROUND ART

In order to remotely support work in a facility such as a substation, it is required to generate three-dimensional data of the facility. Patent Literature 1 discloses synthesizing point cloud data acquired by portable scanners placed at a plurality of locations near the ground and generating three-dimensional data. Since the point cloud data acquired by each of the portable scanners include a side surface of a common object or the like, the point cloud data can be synthesized by aligning side surfaces of the common object.

Patent Literature 1: Japanese Unexamined Patent Application Publication No. 2017-166933

### SUMMARY

When generating three-dimensional data of a facility installed in a large site such as a substation, there is a case where a laser scanner is mounted on a flying object such as a drone, and three-dimensional data are generated by using measurement data measured by the laser scanner. It is also possible to generate three-dimensional data of the entire facility by combining three-dimensional data generated by using the measurement data measured by the flying object as described above and three-dimensional data generated by using measurement data measured by an apparatus installed on the ground. However, the three-dimensional data generated by using the measurement data measured by the flying object and the three-dimensional data generated by using the measurement data measured by the apparatus installed on the ground differ greatly from each other in measurement location, and thus there are few common measurement locations. Therefore, there is a problem that highly accurate three-dimensional data cannot be generated by combining three-dimensional data generated by using measurement data measured by a flying object and three-dimensional data generated by using measurement data measured by an apparatus installed on the ground.

An example object of the present disclosure is to provide a three-dimensional data generation apparatus, a three-dimensional data generation method, and a program that are capable of generating highly accurate three-dimensional data by combining three-dimensional data generated based on measurement data measured by using apparatuses in different measurement locations.

In a first example aspect according to the present disclosure, a three-dimensional data generation apparatus includes: an acquisition unit configured to acquire first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region; a correction unit configured to correct a position between first two-dimensional data generated by viewing the first three-dimensional data with a vertically oriented viewpoint from above and second two-dimensional data generated by viewing the second three-dimensional data with a vertically oriented viewpoint from above; and a synthesis unit configured to synthesize the first three-dimensional data and the second three-dimensional data by using a correction result.

In a second example aspect according to the present disclosure, a three-dimensional data generation method includes: acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region; correcting a position between first two-dimensional data generated by viewing the first three-dimensional data with a vertically oriented viewpoint from above and second two-dimensional data generated by viewing the second three-dimensional data with a vertically oriented viewpoint from above; and synthesizing the first three-dimensional data and the second three-dimensional data by using a correction result.

In a third example aspect according to the present disclosure, a program causes a computer to execute: acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region; correcting a position between first two-dimensional data generated by viewing the first three-dimensional data with a vertically oriented viewpoint from above and second two-dimensional data generated by viewing the second three-dimensional data with a vertically oriented viewpoint from above; and synthesizing the first three-dimensional data and the second three-dimensional data by using a correction result.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram of a three-dimensional data generation apparatus according to the present disclosure;

FIG. 2 is a diagram describing a flow of three-dimensional data generation processing according to the present disclosure;

FIG. 3 is a configuration diagram of the three-dimensional data generation apparatus according to the present disclosure;

FIG. 4 is an overall diagram of a monitoring target facility according to the present disclosure;

FIG. 5 is a diagram illustrating lower point cloud data viewed from viewpoints A to D according to the present disclosure;

FIG. 6 is a diagram illustrating the lower point cloud data viewed from a viewpoint E according to the present disclosure;

FIG. 7 is a diagram illustrating upper point cloud data viewed from the viewpoints A to D according to the present disclosure;

FIG. 8 is a diagram illustrating the upper point cloud data viewed from the viewpoint E according to the present disclosure;

FIG. 9 is a diagram illustrating ground surface-removed lower point cloud data according to the present disclosure;

FIG. 10 is a diagram illustrating ground surface-removed upper point cloud data according to the present disclosure;

FIG. 11 is a diagram illustrating the ground surface-removed lower point cloud data and the ground surface-removed upper point cloud data according to the present disclosure;

FIG. 12 is a diagram illustrating a ground surface when the lower point cloud data and the upper point cloud data are viewed from the viewpoint C according to the present disclosure;

FIG. 13 is diagram describing a flow of the three-dimensional data generation processing according to the present disclosure; and

FIG. 14 is a configuration diagram of the three-dimensional data generation apparatus according to the present disclosure.

### EXAMPLE EMBODIMENT

### First Example Embodiment

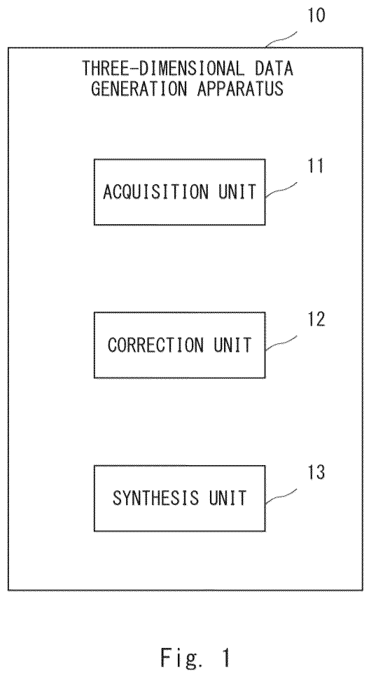

Hereinafter, a configuration example of a three-dimensional data generation apparatus 10 is described with reference to FIG. 1. The three-dimensional data generation apparatus 10 may be a computer apparatus that operates when a processor executes a program stored in a memory. For example, the three-dimensional data generation apparatus 10 may be an information processing apparatus or a server apparatus.

The three-dimensional data generation apparatus 10 includes an acquisition unit 11, a correction unit 12, and a synthesis unit 13. The acquisition unit 11, the correction unit 12, and the synthesis unit 13 may be software or modules that execute processing when a processor executes a program stored in a memory. Alternatively, the acquisition unit 11, the correction unit 12, and the synthesis unit 13 may be hardware such as a circuit or a chip.

The acquisition unit 11 acquires first three-dimensional data indicating a predetermined region and generated by using a first three-dimensional data generation apparatus installed on the ground surface and second three-dimensional data indicating the predetermined region and generated by using a second three-dimensional data generation apparatus from above the predetermined region. The acquisition unit 11 may be used as a means for acquiring the first and second three-dimensional data.

The ground surface may be referred to as the ground, the above-ground surface, or the like. The three-dimensional data generation apparatus may be, for example, an apparatus for measuring a distance to an object. The apparatus for measuring a distance to an object may be, for example, a LiDAR apparatus. The LiDAR apparatus measures the distance to an object by using the time of flight (ToF) method, and generates a point indicating the shape of the object. A set of such points indicating the shape of the object becomes point cloud data. The point indicating the shape of the object may be determined by using three-dimensional coordinates in a predetermined space. In other words, the point indicating the shape of the object may be indicated by using three-dimensional coordinates in a predetermined coordinate system. The three-dimensional data may be point cloud data being a set of points determined using three-dimensional coordinates.

The predetermined region may be, for example, a region in which a plurality of facilities having similar appearance, such as a substation or a power plant, are arranged.

The first three-dimensional data may be generated based on, for example, a plurality of pieces of point cloud data indicating a distance to an object in the predetermined region measured at a plurality of locations on the ground surface. Alternatively, the first three-dimensional data may be generated based on a plurality of pieces of captured data acquired by capturing images of the predetermined region at a plurality of locations on the ground surface. Specifically, the first three-dimensional data generation apparatus may generate three-dimensional data of an object arranged in the predetermined region from a plurality of pieces of captured data, using structure from motion (SfM).

The second three-dimensional data generation apparatus may be mounted on a flying object flying over the predetermined region, for example. The second three-dimensional data generation apparatus, while on a path on which the flying object flies, may measure a distance to an object in the predetermined region, or may capture images of the object in the predetermined region.

The correction unit 12 corrects the position between first two-dimensional data based on generated by viewing the first three-dimensional data with a vertically oriented viewpoint from above and second two-dimensional data generated by viewing the second three-dimensional data with a vertically oriented viewpoint from above. The correction unit 12 may be used as a means for correcting a position between the first and second two-dimensional data.

The first two-dimensional data may be generated, for example, by projecting three-dimensional data indicating an object existing in the predetermined region onto a plane included in the first three-dimensional data. The second two-dimensional data may be generated similarly to the first two-dimensional data. The plane included in the first three-dimensional data and the second three-dimensional data may be, for example, a horizontal plane orthogonal to the vertical direction. For example, each of the first two-dimensional data and the second two-dimensional data may be generated by projecting point cloud data of an object within a predetermined region onto the ground surface. It is assumed that the vertical direction of each of the first three-dimensional data and the second three-dimensional data is a direction orthogonal to the ground surface and coincides with each other.

For example, the correction unit 12 may perform correction in such a way that the first two-dimensional data are aligned with the position indicated by the second two-dimensional data. Specifically, the position of the first two-dimensional data or the position of the second two-dimensional data may be corrected in such a way as to align the positions of the object commonly included in the first two-dimensional data and the second two-dimensional data.

The synthesis unit 13 synthesizes the first three-dimensional data and the second three-dimensional data by using the correction result. The synthesis unit 13 may be used as a means for synthesizing the first and second three-dimensional data. The correction result may be, for example, a movement amount when at least one of the position of the first two-dimensional data and the position of the second two-dimensional data is moved. For example, moving the position of the first two-dimensional data may be rotating or shifting the first two-dimensional data to match the second two-dimensional data. Alternatively, moving the position of the first two-dimensional data may be rotating and shifting the first two-dimensional data to match the second two-dimensional data.

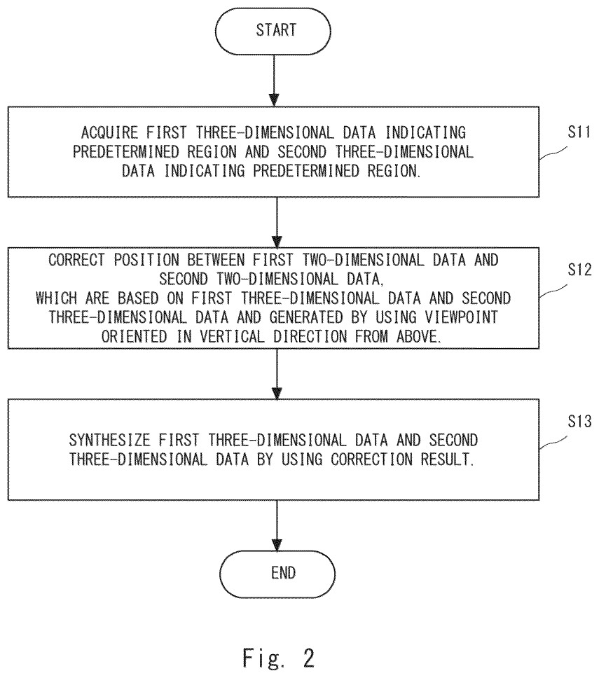

Next, a flow of three-dimensional data generation processing executed in the three-dimensional data generation apparatus is described with reference to FIG. 2. First, the acquisition unit 11 acquires the first three-dimensional data and the second three-dimensional data (S11). The first three-dimensional data are data indicating the predetermined region and generated by using the first three-dimensional data generation apparatus installed on the ground surface. The second three-dimensional data are data indicating the predetermined region and generated by using the second three-dimensional data generation apparatus from above the predetermined region.

Next, the correction unit 12 corrects the position between the first two-dimensional data generated by viewing the first three-dimensional data with a vertically oriented viewpoint from above and the second two-dimensional data generated by viewing the second three-dimensional data with a vertically oriented viewpoint from above (S12).

Next, the synthesis unit 13 synthesizes the first three-dimensional data and the second three-dimensional data by using the correction result (S13).

As described above, the three-dimensional data generation apparatus 10 generates the first two-dimensional data from the first three-dimensional data and generates the second two-dimensional data from the second three-dimensional data by using a common viewpoint being a viewpoint oriented in the vertical direction from above the predetermined region. The three-dimensional data generation apparatus 10 applies the result of correction performed to align the first two-dimensional data and the second two-dimensional data to the synthesis of the first three-dimensional data and the second three-dimensional data. As a result, the three-dimensional data generation apparatus 10 is able to combine the first and second three-dimensional data with high accuracy by using the two-dimensional data generated by using the common viewpoint, even when there are few similar feature points on the appearance of the first and second three-dimensional data.

### Second Example Embodiment

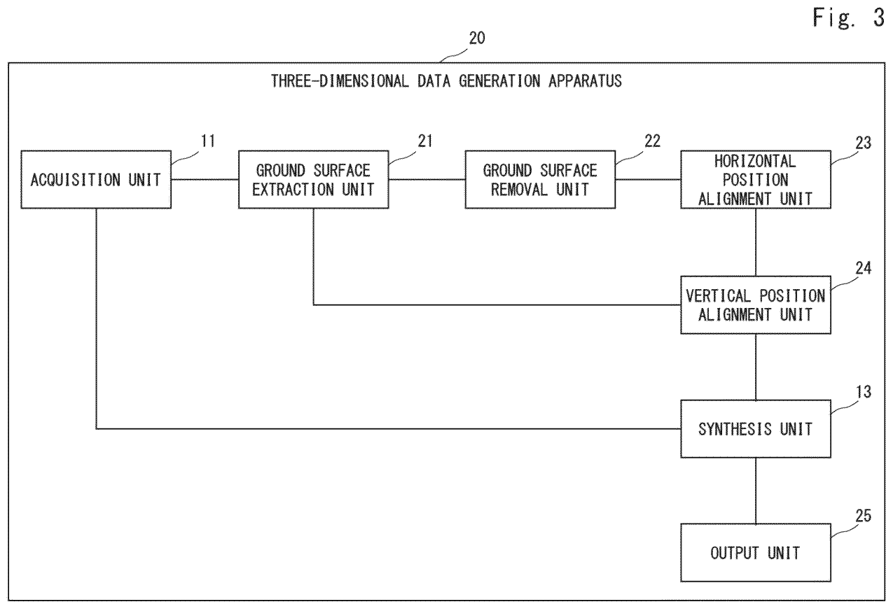

Next, a configuration example of a three-dimensional data generation apparatus 20 is described with reference to FIG. 3. The three-dimensional data generation apparatus 20 has a configuration in which a ground surface extraction unit 21, a ground surface removal unit 22, a horizontal position alignment unit 23, a vertical position alignment unit 24, and an output unit 25 are added to the three-dimensional data generation apparatus 10 of FIG. 1. The horizontal position alignment unit 23 and the vertical position alignment unit 24 correspond to the correction unit 12 in the three-dimensional data generation apparatus 10. In the following, detailed description of the same functions or operations as those in FIG. 1 is omitted.

The acquisition unit 11 acquires point cloud data generated by a LiDAR apparatus installed on the ground surface. Point cloud data are generated, for example, by a LiDAR apparatus measuring a distance to an object. An acquisition unit 11 may acquire point cloud data in which point cloud data generated by a plurality of LiDAR apparatuses in different installation locations are combined. Alternatively, the acquisition unit 11 may acquire point cloud data from a plurality of LiDAR apparatuses. In such a case, the acquisition unit 11 may generate point cloud data in which a plurality of pieces of point cloud data are combined. Combining a plurality of pieces of point cloud data may be superimposing points having a feature amount common to the plurality of pieces of point cloud data. Further, combining the point cloud data may be combining a plurality of pieces of point cloud data in such a way as to complement point cloud data of a portion not indicated in the plurality of pieces of point cloud data. That is, by combining the plurality of pieces of point cloud data, it is possible to indicate the shape of the object existing in the predetermined region with high accuracy. Combining point cloud data may be coupling a plurality of pieces of point cloud data. Highly accurately indicating the shape of the object may be precisely indicating the shape of the object.

Further, the acquisition unit 11 acquires point cloud data generated by a LiDAR apparatus mounted on a flying object moving above a predetermined area. The LiDAR apparatus generates point cloud data at a plurality of locations during moving. The acquisition unit 11 may acquire point cloud data in which a plurality of pieces of point cloud data are combined, or may acquire each piece of point cloud data generated at a plurality of locations. When pieces of point cloud data generated at a plurality of locations are acquired, the acquisition unit 11 may combine the pieces of point cloud data.

Point cloud data in which pieces of point cloud data acquired by the acquisition unit 11 from a LiDAR apparatus installed on the ground surface are combined are referred to as lower point cloud data, and point cloud data in which pieces of point cloud data acquired from a LiDAR apparatus moving above are combined are referred to as upper point cloud data.

It is assumed that the lower point cloud data are three-dimensional data having a coordinate axis in a vertical direction with respect to the ground surface. The LiDAR apparatus installed on the ground surface may be installed so as to have a coordinate axis in a vertical direction with respect to the ground surface. The lower point cloud data may be three-dimensional data in a coordinate system constituted by a coordinate axis in a vertical direction and a coordinate axis representing a plane orthogonal to the vertical direction, with the position of the LiDAR apparatus installed on the ground surface as an origin. When a plurality of LiDAR apparatuses are installed on the ground surface, the position of any of the LiDAR apparatuses may be set as the origin.

It is assumed that the upper point cloud data are three-dimensional data having a coordinate axis in a vertical direction with respect to the ground surface. It is assumed that the LiDAR apparatus installed in a flying object can determine the vertical direction by using an acceleration sensor or the like, for example. The upper point cloud data may be three-dimensional data in a coordinate system constituted by a coordinate axis in a vertical direction and a coordinate axis representing a plane orthogonal to the vertical direction, with the position of the LiDAR apparatus installed in the flying object as an origin. Since the flying object moves, for example, the position of the LiDAR apparatus at the time when the measurement is started may be set as the origin.

The acquisition unit 11 outputs the lower point cloud data and the upper point cloud data to the ground surface extraction unit 21 and a synthesis unit 13.

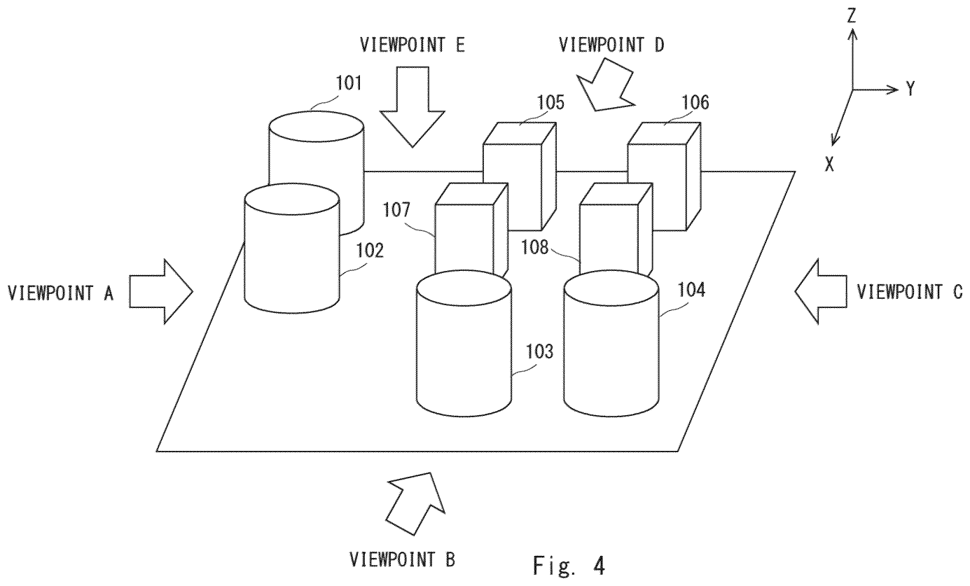

Herein, the lower point cloud data and the upper point cloud data are described with reference to FIGS. 4 to 8. FIG. 4 illustrates an overall diagram of the facility to be monitored. The facility to be monitored may be, for example, a substation. The facility to be monitored includes equipment A101 to equipment A104 and equipment B105 to equipment B108. The equipment A and the equipment B may be, for example, transformers, breakers, and the like. It is assumed that the equipment A101 to equipment A104 are similar in appearance, and the equipment B105 to equipment B108 are similar in appearance. The coordinate axis in the vertical direction with respect to the ground surface is defined as a Z-axis, and a coordinate axis representing the ground surface is defined as an X-axis and a Y-axis. It is assumed that the X-axis, the Y-axis, and the Z-axis are orthogonal to one another.

Viewpoints A to D are viewpoints when the facility to be monitored is viewed from the side. For example, the viewpoint A and the viewpoint C may be viewpoints in the Y-axis direction, and the viewpoint B and the viewpoint D may be viewpoints in the X-axis direction. Viewpoint E is a viewpoint when the facility to be monitored is viewed from above. For example, the viewpoint E may be a viewpoint in the Z-axis direction.

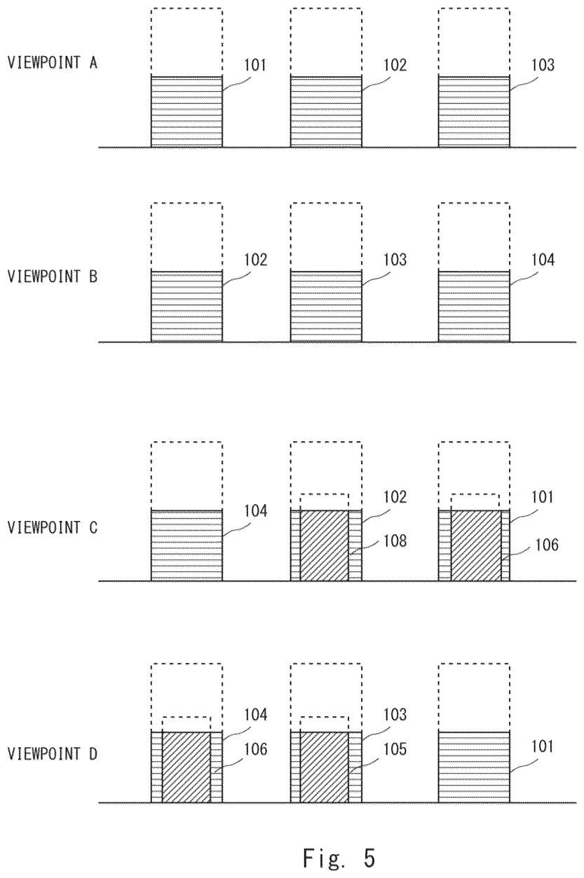

FIG. 5 is a diagram illustrating the lower point cloud data viewed from viewpoints A to D. The lower point cloud data and the upper point cloud data are three-dimensional data in which point cloud data generated by measuring the facility to be monitored from a plurality of locations are combined. Therefore, for example, the user can confirm the facility to be monitored from various viewpoints by using software or the like for displaying three-dimensional data.

For example, when the facility to be monitored is confirmed from the viewpoint A, lower portions of the equipment A101, the equipment A102, and the equipment A103 are displayed. The dotted lines in FIG. 5 indicate non-displayed portions of each piece of equipment. The LiDAR apparatus installed on the ground generates point cloud data of each piece of equipment by irradiating equipment located at a higher position than the LiDAR apparatus with a laser in an angle looking up from below. The irradiation range of the laser is limited to the range of the viewing angle of the LiDAR. Therefore, in a case where the LiDAR apparatus is installed near the facility in order to acquire the point cloud data with high accuracy or high point density, the upper portion of the facility exceeds the range of the viewing angle, and in the lower point cloud data, point cloud data of the upper portion of the facility cannot be acquired. As a result, the point cloud data of the upper portion of the facility are not displayed as illustrated in FIG. 5. In FIG. 5, it is assumed that point cloud data are acquired for a shaded region surrounded by a solid line. The region in which point cloud data are acquired is a region that can be visually recognized through a display unit such as a display.

When the facility to be monitored is confirmed from the viewpoint B, the lower portions of the equipment A102, the equipment A103, and the equipment A104 are displayed. When the facility to be monitored is confirmed from the viewpoint C, the lower portions of the equipment A104, the equipment A102, and the equipment A101 and the lower portions of the equipment B108 and the equipment B106 are displayed. When the facility to be monitored is confirmed from the viewpoint D, the lower portions of the equipment A104, the equipment A103, and the equipment A101 and the lower portions of the equipment B106 and the equipment B105 are displayed.

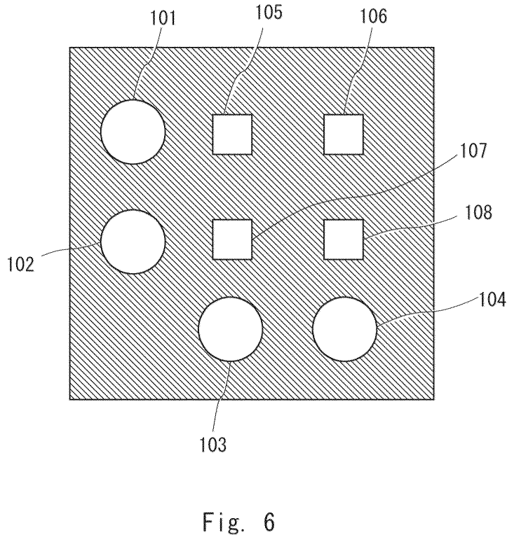

FIG. 6 is a diagram illustrating the lower point cloud data viewed from the viewpoint E. The laser radiated from the LiDAR apparatus installed on the ground does not reach the upper surfaces of the equipment A101 to the equipment A104 and the equipment B105 to the equipment B108. Therefore, FIG. 6 illustrates that the point cloud data on the upper surfaces of the equipment A101 to the equipment A104 and the equipment B105 to the equipment B108 are not acquired, and mainly the point cloud data on the ground surface are acquired.

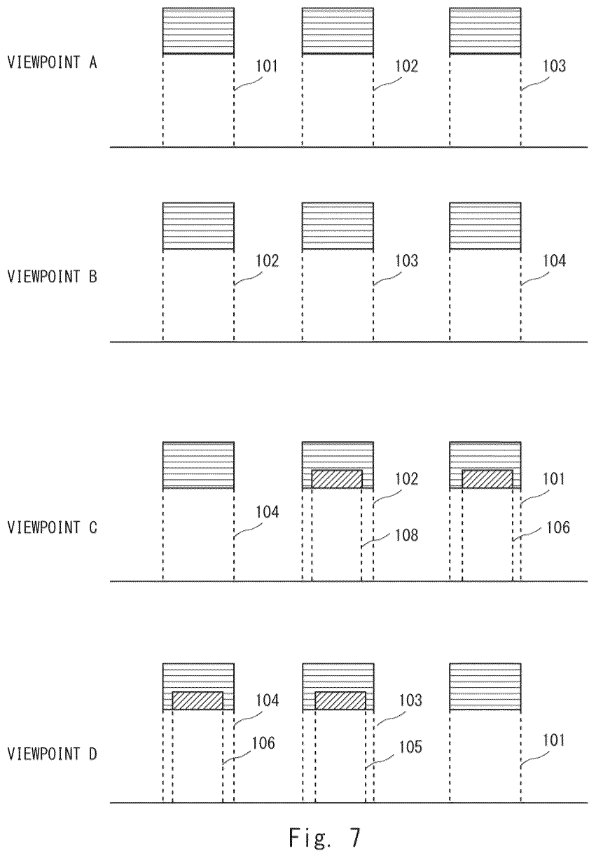

FIG. 7 is a diagram illustrating the upper point cloud data viewed from the viewpoints A to D. When the facility to be monitored is confirmed from the viewpoint A, the upper portions of the equipment A101, the equipment A102, and the equipment A103 are displayed. The dotted lines in FIG. 7 indicate the non-displayed portions of each piece of the equipment. The LiDAR apparatus moving above generates point cloud data for each piece of the equipment by irradiating equipment at a lower position than the LiDAR apparatus with a laser. When point cloud data are acquired from above, the laser is irradiated not only downward in the vertical direction but also in a direction obliquely incident on the ground surface in the range of the viewing angle of LiDAR. Therefore, since the laser reaches not only the upper surface of the equipment but also a surface orthogonal to the ground surface, point cloud data of both the upper surface and the upper portion of the equipment are acquired. Meanwhile, depending on the arrangement of the equipment, the laser does not reach the lower portion of the equipment, and the point cloud data of the lower portion of the equipment cannot be acquired. As a result, as illustrated in FIG. 7, in the upper point cloud data, the lower point cloud data of the equipment are not displayed. In FIG. 7, it is assumed that point cloud data are acquired for a shaded region surrounded by a solid line. The region in which point cloud data are acquired is a region that can be visually recognized through a display unit such as a display.

When the facility to be monitored is confirmed from the viewpoint B, the upper portions of the equipment A102, the equipment A103, and the equipment A104 are displayed. When the facility to be monitored is confirmed from the viewpoint C, the upper portions of the equipment A104, the equipment A102, and the equipment A101 and the upper portions of the equipment B108 and the equipment B106 are displayed. When the facility to be monitored is confirmed from the viewpoint D, the upper portions of the equipment A104, the equipment A103, and the equipment A101 and the upper portions of the equipment B106 and the equipment B105 are displayed.

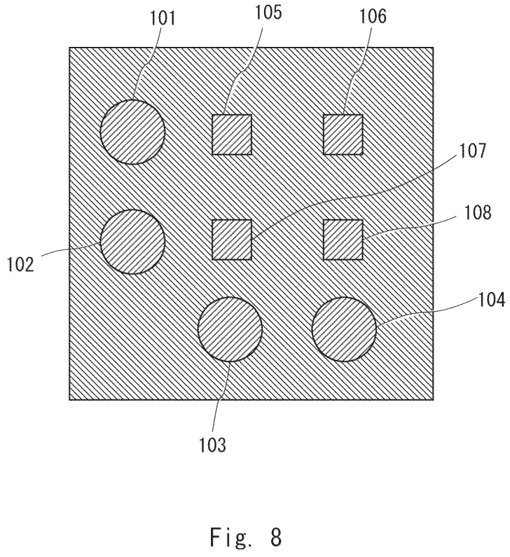

FIG. 8 is a diagram illustrating the upper point cloud data viewed from the viewpoint E. The laser irradiated from the LiDAR apparatus moving above reaches the upper surfaces of the equipment A101 to the equipment A104 and the equipment B105 to the equipment B108 and the ground surface. Therefore, FIG. 8 illustrates that point cloud data of the upper surfaces of the equipment A101 to the equipment A104 and the equipment B105 to the equipment B108 and the ground surface are acquired.

Returning to FIG. 3, the ground surface extraction unit 21 extracts the ground surface from the lower point cloud data and the upper point cloud data. The ground surface extraction unit 21 determines at least one or more planes in each of the lower point cloud data and the upper point cloud data. In other words, the ground surface extraction unit 21 determines the point cloud data constituting the plane in each of the lower point cloud data and the upper point cloud data. The point cloud data constituting the plane are a set of points constituting the plane. For example, for each point having three-dimensional information, the ground surface extraction unit 21 may determine a plurality of points having the same value of a specific coordinate axis as point cloud data constituting the plane.

The ground surface extraction unit 21 may extract, from each of the lower point cloud data and the upper point cloud data, the lowermost plane among the planes orthogonal to the vertical direction as the ground surface. The point cloud data constituting the plane orthogonal to the vertical direction may be, for example, a set of points having the same value in the coordinate axis in the vertical direction. In a case where the value in the coordinate axis in the vertical direction becomes smaller as approaching the ground surface, the lowermost plane among the planes orthogonal to the vertical direction may be a plane having the smallest value in the coordinate axis in the vertical direction. In addition, among the point cloud data constituting a plane orthogonal to the vertical direction and grouped by a method such as Euclidean clustering, a group having the widest range in which points are distributed may be used as the ground surface, or a group having the largest number of points may be used as the ground surface.

The ground surface removal unit 22 removes, from the lower point cloud data, point cloud data constituting the ground surface included in the lower point cloud data. Removing may be referred to as deleting. The lower point cloud data from which the point cloud data constituting the ground surface included in the lower point cloud data are removed are referred to as ground surface-removed lower point cloud data. Further, the ground surface removal unit 22 removes, from the upper point cloud data, point cloud data constituting the ground surface included in the upper point cloud data. The upper point cloud data from which the point cloud data constituting the ground surface included in the upper point cloud data are removed are referred to as ground surface-removed upper point cloud data.

The horizontal position alignment unit 23 projects the ground surface-removed removed lower point cloud data on a horizontal plane. Projecting may be referred to as projection. The horizontal plane is any plane orthogonal to the vertical direction, and may be, for example, the ground surface. When the ground surface-removed lower point cloud data are projected on the ground surface, since the point cloud data constituting the ground surface are removed, the ground surface-removed lower point cloud data projected on the ground surface indicate two-dimensional data of the shape of the object installed on the ground surface.

The horizontal position alignment unit 23 projects the ground surface-removed upper point cloud data on the horizontal plane in a similar manner.

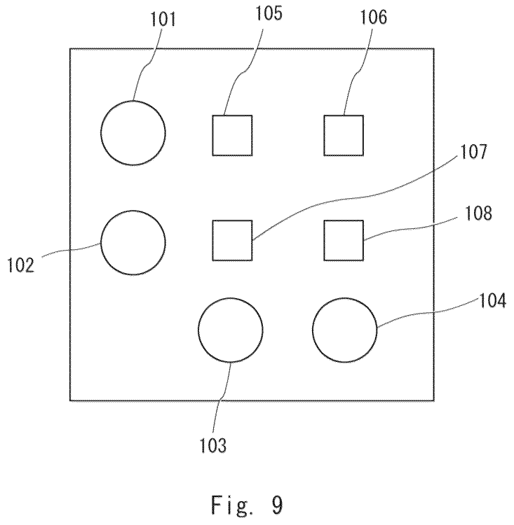

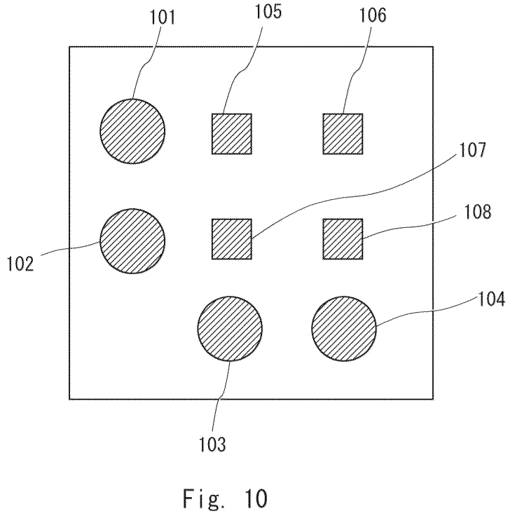

The ground surface-removed lower point cloud data projected on the horizontal plane are data wherein the point cloud data constituting the ground surface are removed from the figure in FIG. 6 illustrating the lower point cloud data being viewed from the viewpoint E, and is displayed, for example, as illustrated in FIG. 9. FIG. 9 illustrates the outline of each pieces of equipment when each pieces of equipment is viewed from the viewpoint E. The ground surface-removed upper point cloud data projected on the horizontal plane are data wherein the point cloud data constituting the ground surface are removed from the figure in FIG. 8 illustrating the upper point cloud data viewed from the viewpoint E, and are displayed, for example, as illustrated in FIG. 10. FIG. 10 illustrates the upper surfaces of each piece of equipment when each piece of equipment is viewed from the viewpoint E.

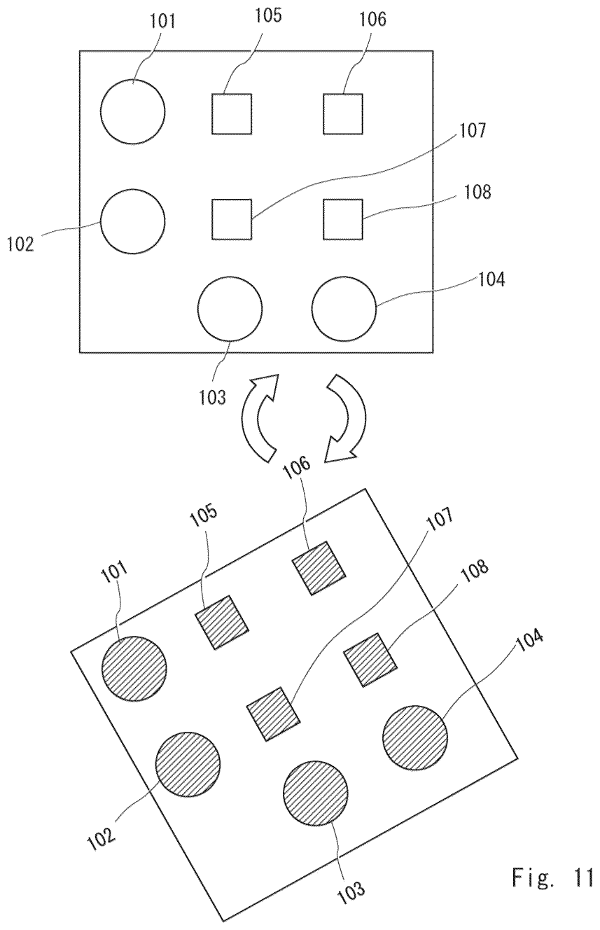

In the ground surface-removed lower point cloud data and the ground surface-removed upper point cloud data that are projected on the horizontal plane, the coordinate axes (Z-axis) in the vertical direction coincide with each other, but the coordinate axes (X-axis and Y-axis) in the direction orthogonal to the vertical direction do not coincide with each other. Therefore, as illustrated in FIG. 11, for example, the ground surface-removed upper point cloud data are point cloud data that are displayed in an inclined manner with respect to the ground surface-removed lower point cloud data.

The horizontal position alignment unit 23 corrects the difference between the positions of the ground surface-removed lower point cloud data and the ground surface-removed upper point cloud data that are projected on the horizontal plane. Specifically, the horizontal position alignment unit 23 rotates at least one of the ground surface-removed lower point cloud data and the ground surface-removed upper point cloud data, that are projected on the horizontal plane, about the coordinate axis in the vertical direction. Further, the horizontal position alignment unit 23 shifts at least one of the ground surface-removed lower point cloud data and the ground surface-removed upper point cloud data, that are projected on the horizontal plane, along a coordinate axis orthogonal to the vertical direction. In such a way, the horizontal position alignment unit 23 aligns the ground surface-removed lower point cloud data and the ground surface-removed upper point cloud data that are projected on the horizontal plane.

When the position of the ground surface-removed lower point cloud data projected on the horizontal plane is matched with the position of the ground surface-removed upper point cloud data projected on the horizontal plane, the horizontal position alignment unit 23 determines the rotation amount and the shift amount of the ground surface-removed lower point cloud data. Alternatively, when the position of the ground surface-removed upper point cloud data projected on the horizontal plane is matched with the position of the ground surface-removed lower point cloud data projected on the horizontal plane, the horizontal position alignment unit 23 determines the rotation amount and the shift amount of the ground surface-removed upper point cloud data. Further, when both the ground surface-removed lower point cloud data and the ground surface-removed upper point cloud data that are projected on the horizontal plane are moved, the horizontal position alignment unit 23 determines the rotation amount and the shift amount of the each piece of the point cloud data.

The vertical position alignment unit 24 corrects a difference in position between the ground surface included in the lower point cloud data and the ground surface included in the upper point cloud data. Specifically, the vertical position alignment unit 24 performs vertical position alignment between the ground surface included in the lower point cloud data extracted by the ground surface extraction unit 21 and the ground surface included in the upper point cloud data. The lower point cloud data are three-dimensional data in a coordinate system based on the position of the LiDAR apparatus installed on the ground surface. Therefore, a plane in which the value of the Z-axis is 0 substantially coincides with the ground surface. Meanwhile, the upper point cloud data are three-dimensional data in the coordinate system based on the position of the LiDAR apparatus mounted on a flying object. Therefore, the position where the value of the Z-axis is 0 is the position of the LiDAR apparatus mounted on the flying object, and when the vertical upward direction is a positive value of the Z-axis, the value of the Z-axis of the ground surface is a negative value.

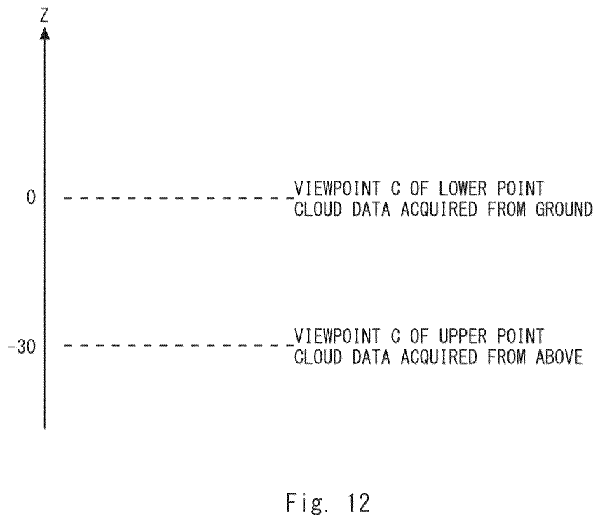

The dotted lines in FIG. 12 indicates the ground surface when the lower point cloud data and the upper point cloud data are viewed from the viewpoint C. Note that, even when the lower point cloud data and the upper point cloud data are viewed from the viewpoints A, B, and D, the ground surface is illustrated in a similar manner as in FIG. 12. Since the value of the Z-axis of the ground surface of the lower point cloud data is substantially equal to 0, the ground surface of the lower point cloud data is at a position where the value of the Z-axis is 0. Meanwhile, in the upper point cloud data, the position of the LiDAR apparatus mounted on the flying object is 0 in the Z-axis. Therefore, it is assumed that the ground surface is at a position of −30 meters, for example. The value of −30 meters being the value of the Z-axis is a value that may be changed depending on, for example, the altitude of the flying object, and is not limited to −30 meters.

The vertical position alignment unit 24 aligns the position or the value of the Z-axis by shifting at least one of the ground surface of the lower point cloud data and the ground surface of the upper point cloud data in the vertical direction. When the position of the ground surface of the lower point cloud data is aligned with the position of the ground surface of the upper point cloud data, the vertical position alignment unit 24 determines the shift amount of the ground surface of the lower point cloud data. Alternatively, when the position of the ground surface of the upper point cloud data is aligned with the position of the ground surface of the lower point cloud data, the vertical position alignment unit 24 determines the shift amount of the ground surface of the upper point cloud data. Further, when both the position of the ground surface of the upper point cloud data and the position of the ground surface of the lower point cloud data are moved, the vertical position alignment unit 24 determines the shift amounts of the ground surface of the upper point cloud data and the ground surface of the lower point cloud data.

The synthesis unit 13 applies the rotation amount and the shift amount determined by the horizontal position alignment unit 23 and the vertical position alignment unit 24 to the lower point cloud data and the upper point cloud data acquired by the acquisition unit 11. That is, the synthesis unit 13 rotates and shifts the lower point cloud data and the upper point cloud data by an amount of rotation and shift of the ground surface-removed lower point cloud data and the ground surface-removed upper point cloud data performed by the horizontal position alignment unit 23 and the vertical position alignment unit 24. As a result, the positions of the lower point cloud data and the upper point cloud data substantially coincide with each other, and the non-displayed portions of each piece of the equipment illustrated in FIGS. 5 and 7 and FIGS. 6 and 8 are complemented to generate highly accurate point cloud data.

The output unit 25 outputs point cloud data acquired by synthesizing the lower point cloud data and the upper point cloud data to a display unit such as a display. Further, the output unit 25 may output the lower point cloud data and the upper point cloud data to the display unit, and may output the lower point cloud data and the upper point cloud data viewed from each viewpoint illustrated in FIGS. 5 to 8 to the display unit. Further, the output unit 25 may output the ground surface-removed lower point cloud data and the ground surface-removed upper point cloud data to the display unit.

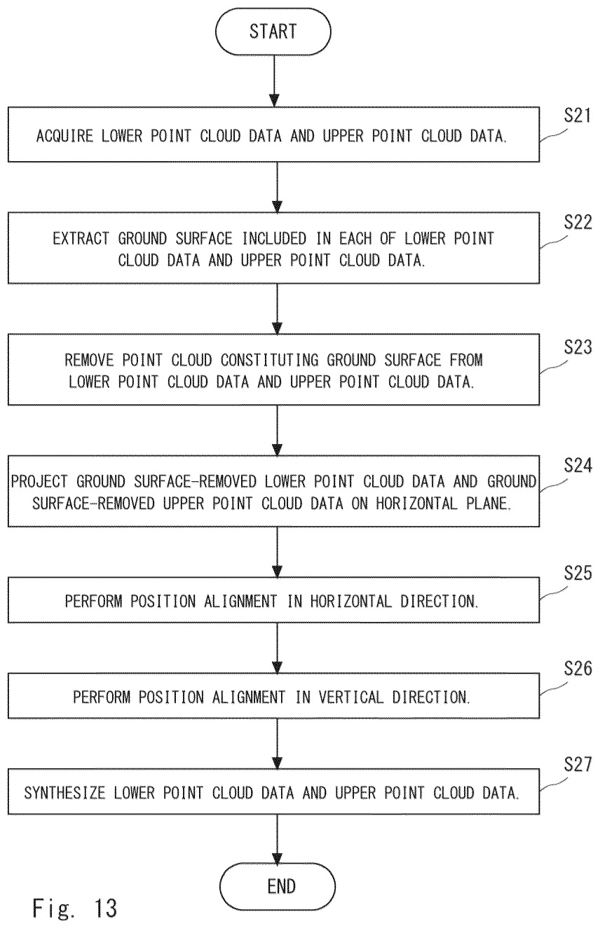

Next, a flow of three-dimensional data generation processing in the three-dimensional data generation apparatus 20 is described with reference to FIG. 13.

First, the acquisition unit 11 acquires the lower point cloud data and the upper point cloud data (S21). Then, the ground surface extraction unit 21 extracts the ground surface included in each piece of the lower point cloud data and the upper point cloud data (S22). Extracting the ground surface may be extracting or determining point cloud data constituting the ground surface.

Next, the ground surface removal unit 22 removes the point cloud data constituting the ground surface from the lower point cloud data and the upper point cloud data (S23). Point cloud data formed by removing point cloud data constituting the ground surface from the lower point cloud data are referred to as the ground surface-removed lower point cloud data, and point cloud data formed by removing point cloud data constituting the ground surface from the upper point cloud data are referred to as the ground surface-removed upper point cloud data.

Next, the horizontal position alignment unit 23 projects the ground surface-removed lower point cloud data and the ground surface-removed upper point cloud data on the horizontal plane (S24). The horizontal plane may be any one of the planes orthogonal to the vertical direction.

Next, the horizontal position alignment unit 23 performs horizontal position alignment of the ground surface-removed lower point cloud data and the ground surface-removed upper point cloud data that are projected on the horizontal plane (S25). The horizontal position alignment unit 23 rotates and shifts, on the horizontal plane, at least one of the ground surface-removed lower point cloud data and the ground surface-removed upper point cloud data that are projected on the horizontal plane. In addition, the horizontal position alignment unit 23 determines the rotation amount and the shift amount of the point cloud data that has been rotated and shifted.

Next, the vertical position alignment unit 24 performs vertical position alignment of the ground surface of each piece of the lower point cloud data and the upper point cloud data that are extracted in step S22 (S26). The vertical position alignment unit 24 shifts at least one of the ground surface of the lower point cloud data and the ground surface of the upper point cloud data in the vertical direction. In addition, the vertical position alignment unit 24 determines the shift amount of the translated ground surface.

Next, the synthesis unit 13 synthesizes the lower point cloud data and the upper point cloud data by applying the rotation amount and the shift amount determined in steps S25 and S26 to the lower point cloud data and the upper point cloud data (S27).

As described above, the three-dimensional data generation apparatus 20 projects the lower point cloud data and the upper point cloud data from which the point cloud data constituting the ground surface have been removed, on the horizontal plane. By removing the point cloud data constituting the ground surface, only the point cloud data indicating the appearance of the object are projected on the horizontal plane. As a result, the three-dimensional data generation apparatus 20 can perform horizontal position alignment based on the shape of the object.

In addition, the three-dimensional data generation apparatus 20 is able to correct a difference in height of a portion where the facility to be monitored is measured by performing vertical position alignment using the ground surface included in the lower point cloud data and the upper point cloud data. The three-dimensional data generation apparatus 20 is able to generate three-dimensional data complementing each piece of the lower point cloud data and the upper point cloud data by using the movement amounts in the horizontal direction and the vertical direction to align the entire lower point cloud data and upper point cloud data.

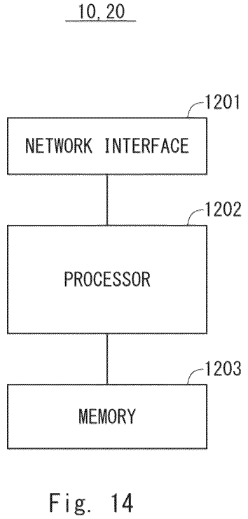

FIG. 14 is a block diagram illustrating a configuration example of the three-dimensional data generation apparatus 10 and the three-dimensional data generation apparatus 20 (hereinafter, referred to as the three-dimensional data generation apparatus 10 or the like). Referring to FIG. 14, the three-dimensional data generation apparatus 10 or the like includes a network interface 1201, a processor 1202, and a memory 1203. The network interface 1201 may be used to communicate with network nodes. The network interface 1201 may include, for example, a network interface card (NIC) compliant with IEEE 802.3 series. IEEE represents the Institute of Electrical and Electronics Engineers.

The processor 1202 reads and executes software (computer program) from the memory 1203 to perform processing of the RU apparatus 10 and the like described with reference to the flowchart in the above-described example embodiment. The processor 1202 may be, for example, a microprocessor, an MPU, or a CPU. The processor 1202 may include a plurality of processors.

The memory 1203 is configured of a combination of a volatile memory and a non-volatile memory. The memory 1203 may include storage located remotely from the processor 1202. In such a case, the processor 1202 may access the memory 1203 via an input/output (I/O) interface (not illustrated).

In the example of FIG. 14, the memory 1203 is used to store software modules. The processor 1202 can read and execute these software modules from the memory 1203 to perform the processing of the three-dimensional data generation apparatus 10 and the like described in the above-described example embodiments.

As described with reference to FIG. 14, each of the processors included in the three-dimensional data generation apparatus 10 or the like executes one or more programs including instructions for causing a computer to perform the algorithm described with reference to the drawings.

In the examples described above, the program includes instructions (or software code) that, when loaded into a computer, cause the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note 1

A three-dimensional data generation apparatus comprising:
an acquisition unit configured to acquire first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
a correction unit configured to correct a position between first two-dimensional data generated by viewing the first three-dimensional data with a vertically oriented viewpoint from above and second two-dimensional data generated by viewing the second three-dimensional data with a vertically oriented viewpoint from above; and
a synthesis unit configured to synthesize the first three-dimensional data and the second three-dimensional data by using a correction result.

### Supplementary Note 2

The three-dimensional data generation apparatus according to Supplementary note 1, wherein the correction unit corrects a difference in position between first projection data acquired by projecting the first three-dimensional data onto the ground surface and second projection data acquired by projecting the second three-dimensional data onto the ground surface.

### Supplementary Note 3

The three-dimensional data generation apparatus according to Supplementary note 2, wherein the correction unit corrects a difference in position between the first projection data that are among the first three-dimensional data and from which point cloud data included in the ground surface are deleted, and the second projection data that are among the second three-dimensional data and from which point cloud data included in the ground surface are deleted.

### Supplementary Note 4

The three-dimensional data generation apparatus according to Supplementary note 2 or 3, wherein the correction unit determines a movement amount for aligning one of positions of the first projection data and the second projection data with another of the positions of the first projection data and the second projection data.

### Supplementary Note 5

The three-dimensional data generation apparatus according to any one of Supplementary notes 1 to 3, wherein the correction unit corrects a difference between a value indicating a vertical height of the first two-dimensional data indicating the ground surface and a value indicating a vertical height of the second two-dimensional data indicating the ground surface.

### Supplementary Note 6

The three-dimensional data generation apparatus according to Supplementary note 5, wherein the correction unit determines a movement amount for aligning one of a value indicating a vertical height of the first two-dimensional data indicating the ground surface and a value indicating a vertical height of the second two-dimensional data indicating the ground surface with another of the value indicating the vertical height of the first two-dimensional data indicating the ground surface and the value indicating the vertical height of the second two-dimensional data indicating the ground surface.

### Supplementary Note 7

The three-dimensional data generation apparatus according to Supplementary note 5, wherein the first two-dimensional data indicating the ground surface are a plane being located at a lowermost position among planes orthogonal to the vertical direction being included in the first three-dimensional data, and the second two-dimensional data indicating the ground surface are a plane being located at a lowermost position among planes orthogonal to the vertical direction being included in the second three-dimensional data.

### Supplementary Note 8

The three-dimensional data generation apparatus according to any one of Supplementary notes 1 to 3, wherein the synthesis unit complements point cloud data within the predetermined region being not included in the first three-dimensional data by using the second three-dimensional data.

### Supplementary Note 9

A three-dimensional data generation apparatus including:
an acquisition unit configured to acquire first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
a first correction unit configured to correct a difference in position between first projection data acquired by projecting the first three-dimensional data onto the ground surface and second projection data acquired by projecting the second three-dimensional data onto the ground surface;
a second correction unit configured to correct a difference between a height of the ground surface included in the first three-dimensional data and a height of the ground surface included in the second three-dimensional data; and
a synthesis unit configured to synthesize the first three-dimensional data and the second three-dimensional data by using a correction result from the first correction unit and a second correction result from the second correction unit.

### Supplementary Note 10

The three-dimensional data generation apparatus according to supplementary note 9, wherein the first projection data are two-dimensional data among the first three-dimensional data, from which point cloud data included in the ground surface are removed, and the second projection data are two-dimensional data among the second three-dimensional data, from which point cloud data included in the ground surface are removed.

### Supplementary Note 11

A three-dimensional data generation apparatus including:
an acquisition unit configured to acquire first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region; and
a synthesis unit configured to synthesize the first three-dimensional data and the second three-dimensional data in such a way as to align coordinate axes of the first three-dimensional data with coordinate axes of the second three-dimensional data.

### Supplementary Note 12

A three-dimensional data generation method comprising:
acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correcting a position between first two-dimensional data generated by viewing the first three-dimensional data with a vertically oriented viewpoint from above and second two-dimensional data generated by viewing the second three-dimensional data with a vertically oriented viewpoint from above; and
synthesizing the first three-dimensional data and the second three-dimensional data by using a correction result.

### Supplementary Note 13

A non-transitory computer-readable medium storing a program for causing a computer to execute:
acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correcting a position between first two-dimensional data generated by viewing the first three-dimensional data with a vertically oriented viewpoint from above and second two-dimensional data generated by viewing the second three-dimensional data with a vertically oriented viewpoint from above; and
synthesizing the first three-dimensional data and the second three-dimensional data by using a correction result.

### Supplementary Note 14

A three-dimensional data generation method including:
acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correcting a difference in position between first projection data acquired by projecting the first three-dimensional data onto the ground surface and second projection data acquired by projecting the second three-dimensional data onto the ground surface;
correcting a difference between a height of the ground surface included in the first three-dimensional data and a height of the ground surface included in the second three-dimensional data; and
synthesizing the first three-dimensional data and the second three-dimensional data by using a correction result.

### Supplementary Note 15

A program for causing a computer to execute:
acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correcting a difference in position between first projection data acquired by projecting the first three-dimensional data onto the ground surface and second projection data acquired by projecting the second three-dimensional data onto the ground surface;
correcting a difference between a height of the ground surface included in the first three-dimensional data and a height of the ground surface included in the second three-dimensional data; and
synthesizing the first three-dimensional data and the second three-dimensional data by using a correction result.

Some or all of elements (e.g., structures and functions) specified in Supplementary Notes 2 to 8 dependent on Supplementary Note 1 may also be dependent on Supplementary Note 12 to Supplementary Note 13 in dependency similar to that of Supplementary Notes 2 to 8 on Supplementary Note 1. Some or all of elements (e.g., structures and functions) specified in Supplementary Note 10 dependent on Supplementary Note 9 may also be dependent on Supplementary Note 14 to Supplementary Note 15 in dependency similar to that of Supplementary Note 10 on Supplementary Note 9. Some or all of elements specified in any of Supplementary Notes may be applied to various types of hardware, software, and recording means for recording software, systems, and methods.

According to the present disclosure, it is possible to provide a three-dimensional data generation apparatus, a three-dimensional data generation method, and a program that are capable of generating highly accurate three-dimensional data by combining three-dimensional data generated based on measurement data measured using apparatuses having different measurement locations.

What is claimed is:

1. A three-dimensional data generation apparatus comprising:
at least one memory storing instructions; and
at least one processor configured to execute the instructions to:
acquire first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correct a position between first two-dimensional data generated by viewing the first three-dimensional data with a vertically oriented viewpoint from above and second two-dimensional data generated by viewing the second three-dimensional data with a vertically oriented viewpoint from above; and
synthesize the first three-dimensional data and the second three-dimensional data by using a correction result.

2. The three-dimensional data generation apparatus according to claim 1, wherein the at least one processor is further configured to execute the instructions to correct a difference in position between first projection data acquired by projecting the first three-dimensional data onto the ground surface and second projection data acquired by projecting the second three-dimensional data onto the ground surface.

3. The three-dimensional data generation apparatus according to claim 2, wherein the at least one processor is further configured to execute the instructions to correct a difference in position between the first projection data that are among the first three-dimensional data and from which point cloud data included in the ground surface are deleted, and the second projection data that are among the second three-dimensional data and from which point cloud data included in the ground surface are deleted.

4. The three-dimensional data generation apparatus according to claim 2 or 3, wherein the at least one processor is further configured to execute the instructions to determine a movement amount for aligning one of positions of the first projection data and the second projection data with another of the positions of the first projection data and the second projection data.

5. The three-dimensional data generation apparatus according to claim 1, wherein the at least one processor is further configured to execute the instructions to correct a difference between a value indicating a vertical height of the first two-dimensional data indicating the ground surface and a value indicating a vertical height of the second two-dimensional data indicating the ground surface.

6. The three-dimensional data generation apparatus according to claim 5, wherein the at least one processor is further configured to execute the instructions to determine a movement amount for aligning one of a value indicating a vertical height of the first two-dimensional data indicating the ground surface and a value indicating a vertical height of the second two-dimensional data indicating the ground surface with another of the value indicating the vertical height of the first two-dimensional data indicating the ground surface and the value indicating the vertical height of the second two-dimensional data indicating the ground surface.

7. The three-dimensional data generation apparatus according to claim 5, wherein the first two-dimensional data indicating the ground surface are a plane being located at a lowermost position among planes orthogonal to the vertical direction being included in the first three-dimensional data, and the second two-dimensional data indicating the ground surface are a plane being located at a lowermost position among planes orthogonal to the vertical direction being included in the second three-dimensional data.

8. The three-dimensional data generation apparatus according to claim 1, wherein the at least one processor is further configured to execute the instructions to complement point cloud data within the predetermined region being not included in the first three-dimensional data by using the second three-dimensional data.

9. A three-dimensional data generation method comprising:
acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correcting a position between first two-dimensional data generated by viewing the first three-dimensional data with a vertically oriented viewpoint from above and second two-dimensional data generated by viewing the second three-dimensional data with a vertically oriented viewpoint from above; and
synthesizing the first three-dimensional data and the second three-dimensional data by using a correction result.

10. A non-transitory computer-readable medium storing a program for causing a computer to execute:
acquiring first three-dimensional data indicating a predetermined region and being generated by using a first three-dimensional data generation apparatus installed on a ground surface, and second three-dimensional data indicating the predetermined region and being generated by using a second three-dimensional data generation apparatus from above the predetermined region;
correcting a position between first two-dimensional data generated by viewing the first three-dimensional data with a vertically oriented viewpoint from above and second two-dimensional data generated by viewing the second three-dimensional data with a vertically oriented viewpoint from above; and
synthesizing the first three-dimensional data and the second three-dimensional data by using a correction result.
